(19) United States
(12) Patent Application Publication
(10) Pub. No.: US 2026/0227230 A1
(43) Pub. Date: Aug. 6, 2026

(54) INTEGRATED SCALE SYSTEM FOR CHECKOUT TERMINAL

(71) Applicant: Walmart Apollo, LLC, Bentonville, AR (US)

(72) Inventors: Darrell Whitelaw, Pacific Palisades, CA (US); Andrew J. Grignon, Roseville, CA (US); Michael C. Cervantes, San Francisco, CA (US); Kristine L. Pachuta, Malibu, CA (US); Gabriel H. Giraldo-Wingler, Doylestown, PA (US); John C. Crecelius, Jr., Springdale, AR (US); Brittany N. Leek, Waterford, MI (US)

(21) Appl. No.: 19/151,964

(22) PCT Filed: Jan. 30, 2024
(86) PCT No.: PCT/US2024/013556

§ 371 Date: Jul. 29, 2025

Related U.S. Application Data
(60) Provisional application No. 63/442,410, filed on Jan. 31, 2023.

(51) Int. Cl. G01G 19/414; G08B 13/24

(52) U.S. Cl. CPC G01G 19/4144; G08B 13/246

(57) ABSTRACT

An integrated scale system for a checkout terminal in a retail environment is provided. The system includes a scale plate, a frame load plate under the scale plate, a plurality of load cells mounted on the frame load plate, and an electronic article surveillance (EAS) label deactivator positioned between the scale plate and the frame load plate. The load cells output signals indicating the weight of an item placed on the scale plate, while the EAS label deactivator is configured to deactivate EAS labels on items placed on the scale plate.

### CROSS-REFERENCE TO RELATED APPLICATION(S)

This application claims the benefit of U.S. Provisional Application No. 63/442,410 filed Jan. 31, 2023, which is incorporated herein by reference in its entirety.

### TECHNICAL FIELD

These teachings relate generally to a scale system of a checkout terminal in a retail environment and specifically to an integrated scale system.

### BACKGROUND

A checkout terminal is typically the point of sale (POS) of a retail store where a retail transaction is completed. At the point of sale, the merchant calculates the amount owed by the customer, indicates that amount, may prepare an invoice for the customer, and indicates the options for the customer to make payment. It is also typically the point at which a customer makes a payment to the merchant in exchange for goods or after provision of a service. Many of the current checkout terminal designs include a weight scale for determining product weight for calculating product prices.

### BRIEF DESCRIPTION OF THE DRAWINGS

Disclosed herein are embodiments of systems and methods for an integrated scale system of a checkout terminal for retail transactions. This description includes drawings, wherein:

FIG. 1 includes an illustration of a scale system in a partially exploded view in accordance with some embodiments;

FIG. 2 includes an illustration of a scale system in an exploded view in accordance with some embodiments;

FIG. 3 includes an illustration of another scale system in an exploded view in accordance with some embodiments;

FIG. 4 includes an illustration of a scale enclosure in accordance with some embodiments;

FIG. 5 includes an illustration of a scale plate and an optical sensor module in accordance with some embodiments;

FIG. 6 includes an illustration of an optical sensor module in accordance with some embodiments;

FIG. 7 includes an illustration of a scale system in another partially exploded view in accordance with some embodiments;

FIG. 8 includes an illustration of a scale system as assembled in accordance with some embodiments;

FIG. 9 includes an illustration of a checkout terminal with a scale system in accordance with some embodiments;

FIG. 10 includes a block diagram of a checkout terminal in accordance with some embodiments; and FIG. 11 includes a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence may not actually be required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices, and methods are provided for a scale system of a checkout terminal for retail transactions. Generally, checkout terminals are point of sale (POS) systems provided in retail stores to process checkout and other retail transactions. A checkout terminal may be a clerk or customer-operated terminal configured to identify products for purchase and accept payment for the purchase. A scale system is a weigh scale device that provides a weight measurement to the POS in processing transactions.

In some aspects, the techniques described herein relate to a checkout terminal apparatus including: a scale plate; a frame load plate under the scale plate; a plurality of load cells mounted on the frame load plate under an edge portion of the scale plate, the load cells being configured to output signals indicating a weight of an item placed on the scale plate; and an electronic article surveillance (EAS) label deactivator positioned between the scale plate and the frame load plate, the EAS label deactivator being configured to deactivate EAS labels on items placed on the scale plate.

In some aspects, the techniques described herein relate to a method for retail checkout including: determining, with a control circuit of a checkout terminal system having a scale system, a weight of one or more items placed on a scale plate of the scale system; processing a transaction based on the weight of the one or more items; and actuating an EAS label deactivator to deactivate one or more EAS labels on the one or more items; wherein the scale system includes: the scale plate; a frame load plate under the scale plate; a plurality of load cells mounted on the frame load plate under an edge portion of the scale plate configured to output signals indicating the weight of items placed on the scale plate; and the EAS label deactivator positioned between the scale plate and the frame load plate.

In some embodiments, the scale system described herein may be configured to couple to a checkout terminal described in PCT Application No. PCT/US2022/044365 filed on Sep. 22, 2022, titled “Checkout Terminal,” and U.S. Provisional Application No. 63/442,391 filed on Jan. 31, 2023, titled “Modular Checkout Terminal” the entirety of which are incorporated herein by reference. In some embodiments, the scale system described may be used to perform one or more steps of the processes and methods described in these applications. In some embodiments, the scale system may be a platter kit described in the above identified US Provisional Application.

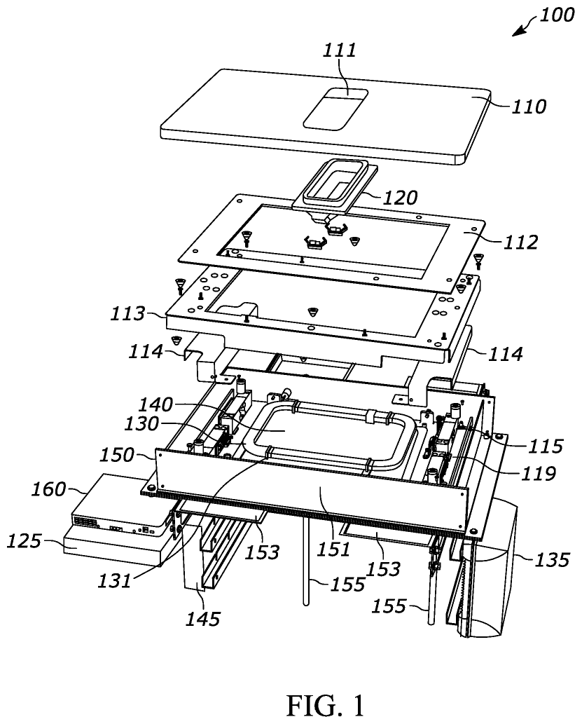

Referring now to the drawings, in FIG. 1 a scale system in an exploded view according to some embodiments is shown. The scale system includes a scale plate 110, an optical sensor module 120, a carrier plate 112, a frame load cell 113, load cell covers 114, and load cells 115, an EAS label deactivator 130, a Radio Frequency Identification (RFID) antenna 140, a load plate 119, an enclosure 150, drainage capture plates 153, drainage tubes 155, a Checkout terminal controller 160, an EAS controller 135, an RFID controller 145, and an optical sensor controller 125.

In some embodiments, the scale plate 110, the carrier plate 112, the frame load cell 113, load cell covers 114, and load cells 115 may collectively be referred to as a weight scale. In some embodiments, the scale plate 110 may be an item receiving surface of the scale system. In some embodiments, the weight on the scale plate 110 rests on the load cells 115 via one or more of the carrier plate 112, the frame load cell 113, and load cells covers 114. In some embodiments, the scale plate 110 includes a window 111 for providing line-of-sight between the sensors of the optical sensor module 120 mounted on the underside of the scale plate 110 and items placed on the top side of the scale plate 110. In some embodiments, the scale plate 110 may be made of a material that does not interfere with the functions of an RFID antenna 140 and an EAS label deactivator 130, such as plastic or glass. In some embodiments, the carrier plate 112 and frame load cell 113 each include an opening at least partially over the RFID antenna 140 and the EAS label deactivator 130. In some embodiments, the region of the scale plate 110 over the opening of the carrier plate 112 may be referred to as the center portion and the region of the scale plate 110 over the carrier plate 112 may be referred to as the edge portion. In some embodiments, the carrier plate 112 secures the scale plate 110 to the scale system 100. In some embodiments, the frame load cell 113 and the load cell covers 114 are configured to distribute the weight on the scale plate 110 between the plurality of load cells 115. In some embodiments, the frame load cell 113 and load cell covers 114 may also serve as spacers between the scale plate 110 and the EAS label deactivator 130. In some embodiments, the scale system 100 includes four or more load cells 115 distributed under the edge portion of the scale plate 110 and mounted on the load plate 119. In some embodiments, the load cells 115 are configured to output a signal indicating a weight measurement to the checkout terminal controller 160. The weight data may be used during checkout transaction to determine the cost of weight variable items such as sold-by-weight produce. In some embodiments, the weight data may further be used to verify the identification of items based on RFID, computer vision (CV), or symbology (e.g. barcode, optical code, QR code, watermark, etc.).

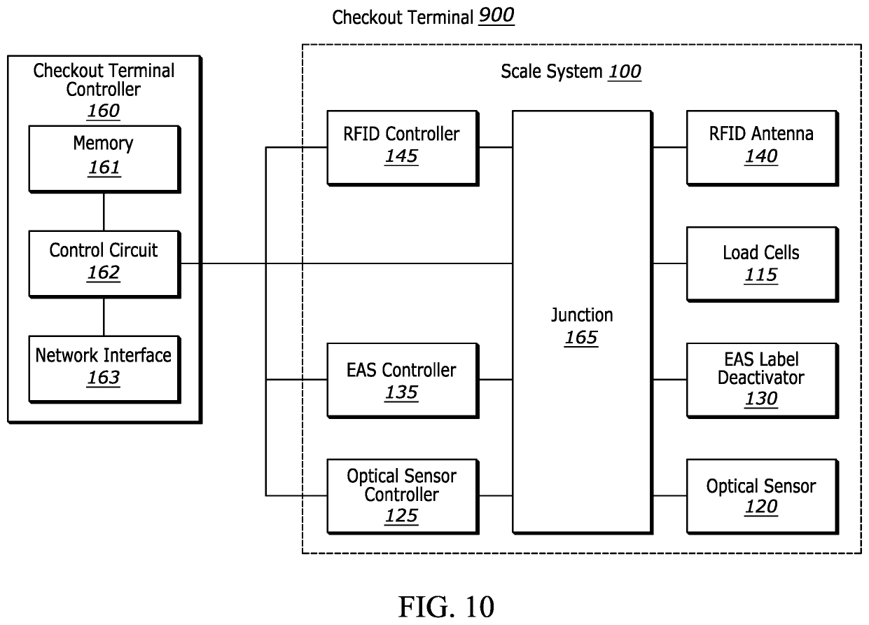

In some embodiments, the optical sensor module 120 comprises one or more optical sensors for capturing symbology information and/or item images from items placed on the scale plate 110. In some embodiments, the optical sensor module 120 is mounted to the underside of the scale plate 110 below the window 111. In some embodiments, the item images captured by the optical sensor module 120 may be used to identify the items based on CV. The optical sensor module 120 may be communicatively coupled to the optical sensor controller 125. In some embodiments, the optical sensor controller 125 is configured to process the images captured by the optical sensor module 120 to extract symbology and/or CV information. In some embodiments, the optical sensor controller 125 may be configured to output item identifiers (e.g. SKU, UPC, GTIN) to the Checkout terminal controller 160. In some embodiments, the optical sensor controller 125 may receive optical sensor data from additional optical sensors located at other locations of a checkout terminal. An example of a checkout terminal having multiple optical sensor modules or kits is described with reference to FIG. 9.

In some embodiments, the EAS label deactivator 130 comprises a coil that is configured to be activated to deactivate EAS labels on items placed on the scale plate 110. In some embodiments, the EAS label deactivator 130 is mounted on the load plate 119 with brackets such that the coil of the EAS label deactivator 130 is spaced apart from the load plate 119 and/or the RFID antenna 140. In some embodiments, the EAS label deactivator 130 may be configured to deactivate electromagnetic EAS labels and/or acousto-magnetic EAS labels through demagnetization. In some embodiments, the EAS label deactivator 130 may be configured to deactivate a radio frequency EAS label by generating a strong electromagnetic field to short-circuit the label. In some embodiments, the EAS label deactivator 130 and/or the RFID antenna 140 is further configured to detect the presence of an EAS label in the item placement area above the scale plate 110. In some embodiments, the EAS label deactivator 130 is communicatively coupled to an EAS controller 135. The EAS controller 135 may be configured to selectively activate the EAS label deactivator 130 based on signals from the checkout terminal controller 160. In some embodiments, the EAS label deactivator 130 may be configured to activate the EAS label deactivator 130 only when weight measurements are not being taken and/or when the RFID antenna 140 is inactive to avoid causing electrical and/or magnetic interference. In some embodiments, the EAS controller 135 may be configured to determine whether an EAS label detected by the EAS label deactivator 130 is a hard deactivation label or a soft deactivation label. In some embodiments, a soft deactivation label refers to a label that can be magnetically or electrically deactivated by the EAS label deactivator 130 such that the label would no longer trigger a loss prevention sensor at the exit of a store. In some embodiments, a hard deactivation label refers to labels that are required to be physically removed, such as an EAS tag secured to articles with a pin or an EAS lockbox.

In some embodiments, the RFID antenna 140 may be configured to detect and read RFID tags on items placed on the scale plate 110. In some embodiment, the RFID antenna 140 includes a radio receiver and transmitter configured to send an electromagnetic interrogation pulse to a nearby RFID tag and receive a signal from the RFID tag. In some embodiments, the signal may include an item identifier (e.g. SKU, UPC, GTIN). In some embodiments, the EAS label deactivator 130 is communicatively coupled to the RFID controller 145. The RFID controller 145 may be configured to process the signal received by the RFID antenna 140 and provide the detected item identifiers to the Checkout terminal controller 160.

In some embodiments, the enclosure 150 comprises side walls 151 and a bottom plate 154 that, together with the scale plate 110 encloses the optical sensor module 120, the carrier plate 112, the frame load cell 113, load cell covers 114, and load cells 115, the EAS label deactivator 130, the Radio Frequency Identification (RFID) antenna 140, the load plate 119, forming a scale system housing. The enclosure 150 may include a set of drainage capture plates 153 for catching liquid that seeps through the edges of the scale plate 110 into the enclosure 150. The drainage capture plates 153 may be connected to drainage tubes 155 that connect the drainage capture plates 153 to an external drainage system and/or a reservoir.

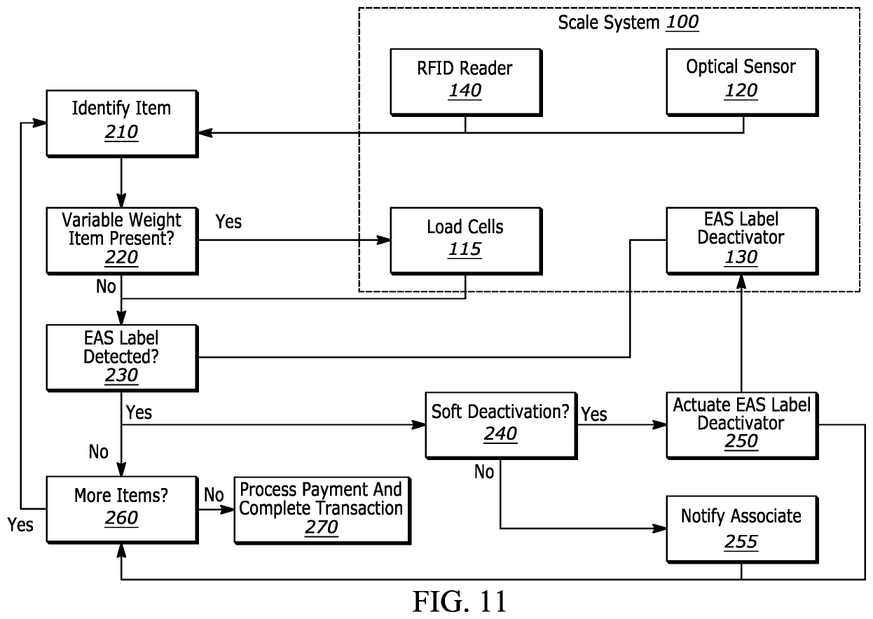

In some embodiments, the checkout terminal controller 160 may be configured to control and coordinate various components of a checkout terminal to process checkout transactions. In some embodiments, the checkout terminal controller 160 may be communicatively coupled to the load cells 115, the optical sensor controller 125, the EAS controller 135, and the RFID controller 145. In some embodiments, the checkout terminal controller 160 may further be communicatively connected to other components of a checkout and a remote backend system. further details of the checkout terminal controller 160 are described with reference to FIGS. 10 and 11 herein.

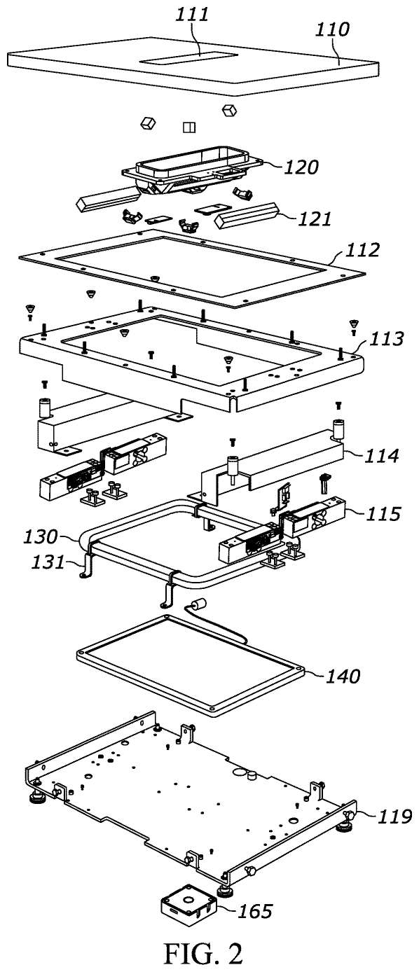

Next referring to FIG. 2, a scale system 100 in an exploded view according to some embodiments is shown. Compared to FIG. 1, FIG. 2 additionally shows the mounting hardware 121 for mounting the optical sensor module 120 to the underside of the scale plate 110 and a junction box 165. In some embodiments, the junction box 165 is mounted under the frame load plate 119 in an opening of the enclosure 150. The junction box 165 may house a cable junction device that provides electrical connections between two or more of the load cells 115, the EAS label deactivator 130, the RFID antenna, an optical sensor module 120, an EAS deactivation controller 135, an optical sensor controller 125, a RFID controller 145, and a checkout terminal controller 160.

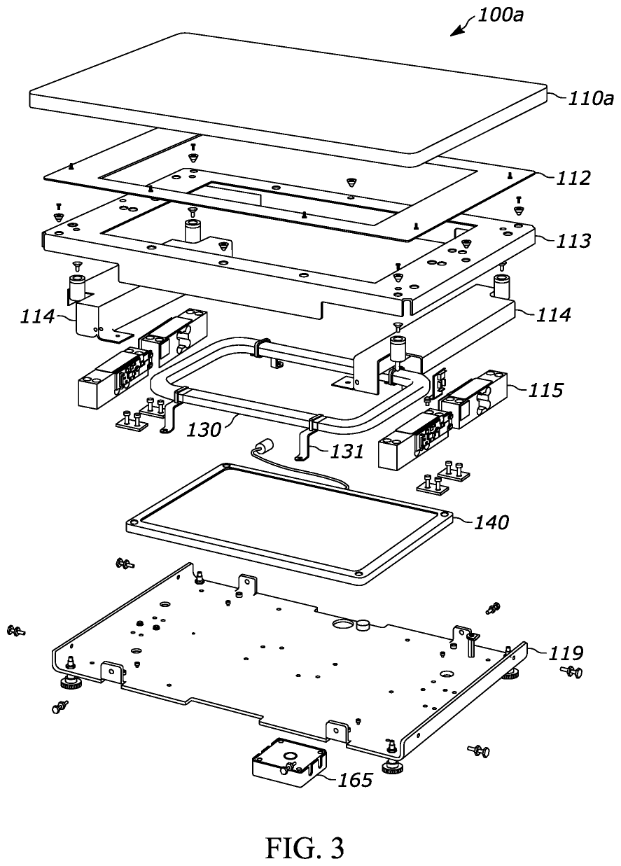

Next referring to FIG. 3, another scale system in an exploded view according to some embodiments is shown. The scale system 100a is a variation of scale system 100 where an optical sensor module 120 is not present. In the scale system 100a, the scale plate 110a does not include a window 111.

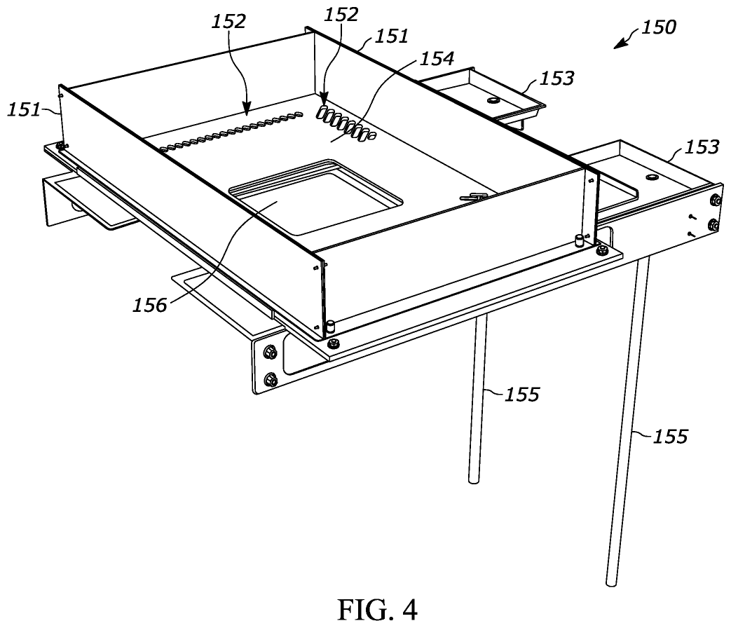

Next referring to FIG. 4, an enclosure 150 according to some embodiments is shown. The enclosure 150 includes side walls 151, a bottom plate 154, two drainage capture plates 153, and two drainage tubes 155. In some embodiments, the bottom plate 154 comprises a center opening 156 for mounting the junction box 165 to the load plate 119 and providing a pathway for wires of the junction box 165 to be connected to other components such as the optical sensor controller 125, the EAS controller 135, the RFID controller 145, and the checkout terminal controller 160. In some embodiments, the bottom plate 154 further comprises drainage openings 152 that allow liquid to drain onto drainage capture plates 153. In some embodiments, drainage openings 152 are sized to prevent credit card and ID pass-through. In some embodiments, the side and shape of the drainage capture plates 153 and drainage tubes 155 may vary depending on the configuration of the checkout terminal that the scale system 100 is installed. In some embodiments, the enclosure 150 further comprises couplers for physically securing the scale system 100 to a checkout terminal.

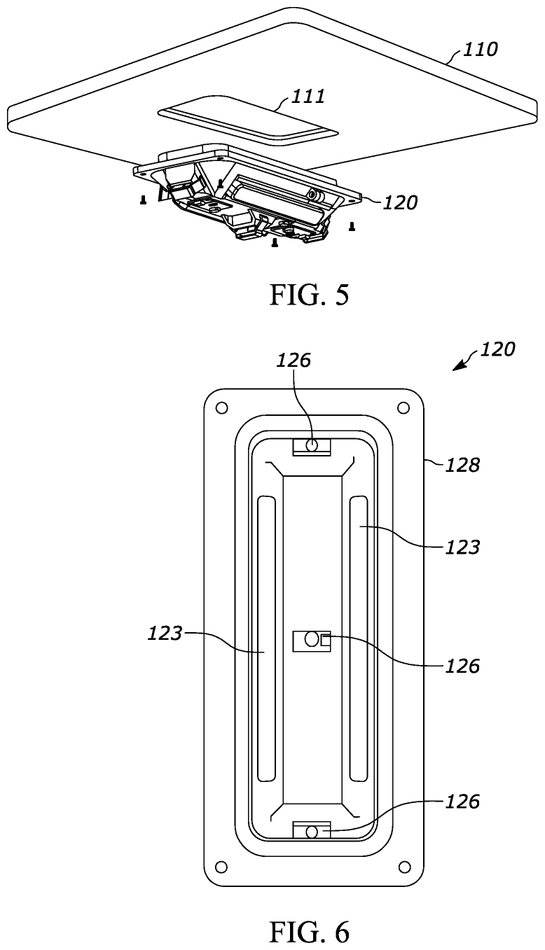

Next referring to FIG. 5, a scale plate and an optical sensor module according to some embodiments are shown. In some embodiments, the scale plate 110 includes a window 111, and the optical sensor module 120 is mounted to the underside of the scale plate 110 through screws. In some embodiments, the window 111 may be an opening through which a transparent cover of the optical sensor module 120 is inserted such that the cover of the optical sensor module 120 is approximately flush with the top surface of the scale plate 110. In some embodiments, the window 111 may comprise a transparent cover and optical sensor module 120 sits below the cover.

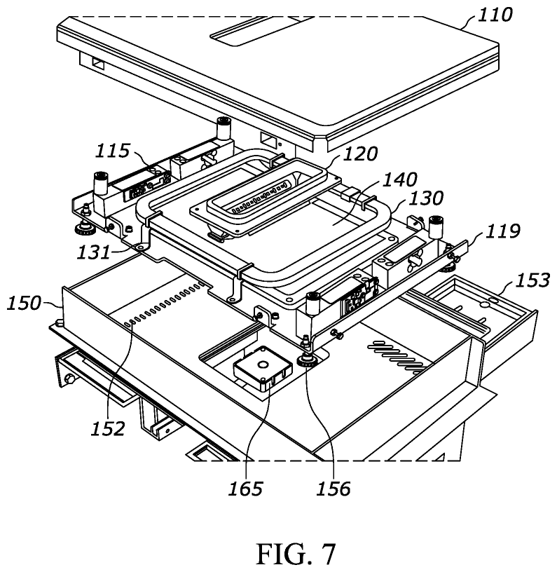

Next referring to FIG. 6, an optical sensor module according to some embodiments is shown. The optical sensor module 120 includes an optical sensor enclosure 128, a sensor array 126, and a lighting array 123. In some embodiments, the lighting array 123 may comprise LED lights for providing illumination to the item receiving area through the window 111. In some embodiments, the lighting array 123 may comprise two discrete light sources on each sides of the optical sensor module 120. In some embodiments, the optical sensor module 120 and/or the checkout terminal may further comprise a light sensor for sensing ambient light to adjust the light level of the lighting array 123. In some embodiments, the optical sensor array may comprise a plurality of cameras mounted in an omnidirectional array to provide different fields of view of the item receiving area above the scale plate 110 to capture images of items passing through the scale plate 110. In some embodiments, the cameras are mounted at three locations along the length of the optical sensor module 120 as shown. In some embodiments, images captured by the cameras are used to extract symbology information associated with items, such as 1D/2D barcodes, digital watermarks, QR codes, ArucoMarkers, Apriltags, etc. In some embodiments, a light pointer/aimer is mounted near each camera of the optical sensor array 126. In some embodiments, the light pointers/aimers may comprise a plurality of LEDs each comprising a single pointer or grouped in multiples to create a pattern. In some embodiments, the LEDs are red-light LEDs.

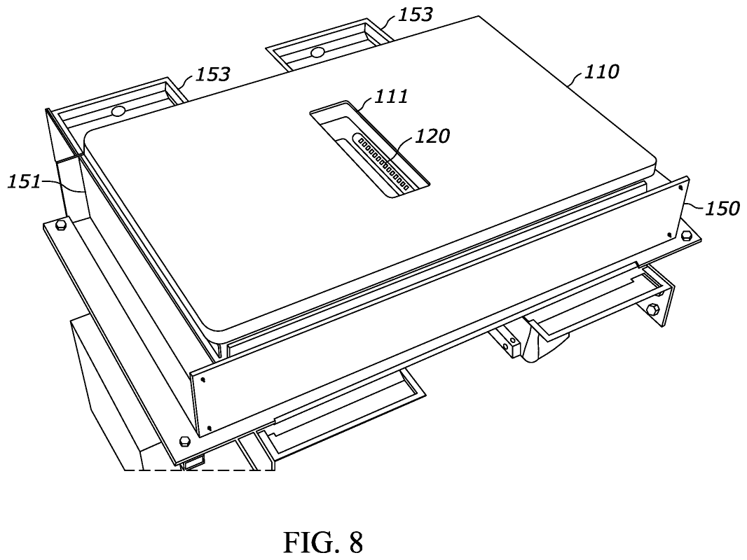

Next referring to FIG. 7, a partially assembled scale system according to some embodiments is shown. In FIG. 7, the RFID antenna 140 and the EAS label deactivator 130 are shown as mounted on the load plate 119 and positioned between the load cells 115, also mounted to the load plate 119. In some embodiments, the EAS label deactivator 130 is mounted on brackets 131 over the RFID antenna 140 such that the coil of the EAS label deactivator 130 does not contact the RFID antenna 140. The optical sensor module 120 is shown to be at least partially surrounded by the coil of the EAS label deactivator 130. In some embodiments, when the scale system 100 is assembled and the optical sensor module 120 is mounted to the scale plate 110, the optical sensor module 120 may have a similar relative position to the EAS label deactivator 130 and RFID antenna 140. FIG. 7 further shows the junction box 165 within the center opening 156 of the enclosure 150. In some embodiments, when the scale system 100 is assembled and the junction box 165 is mounted to the underside of the load plate 119, the junction box 165 may have a similar relative position to the enclosure 150. In some embodiments, the EAS label deactivator 130, the optical sensor module 120, and the load cells 115 mounted on the load plate 119 are configured to be removed as a unit to access the enclosure 150 space below the load plate 119 by removing the scale plate 110 and lifting the load plate 119.

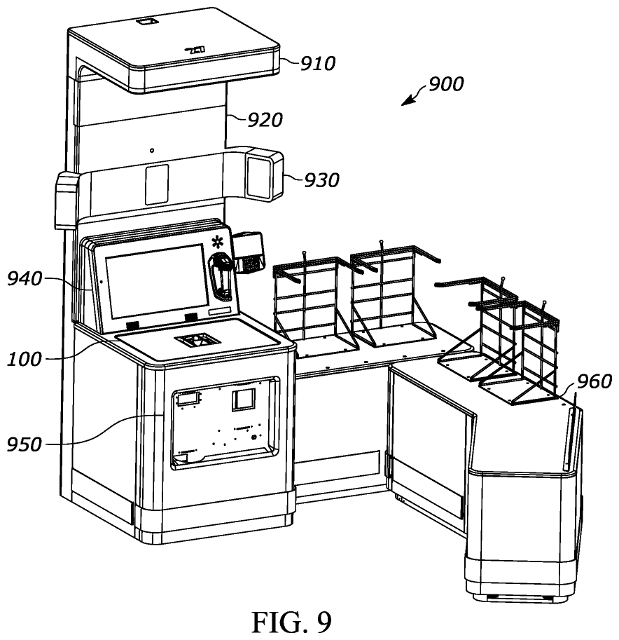

Next referring to FIG. 8, an assembled scale system according to some embodiments is shown. When assembled, the internal components of the scale system 100 are enclosed by the enclosure 150 and the scale plate 110. In some embodiments, a small gap is present between the side walls 151 of the enclosure 150 and the scale plate 110 to allow displacement of the scale plate 110 for weight measurement. In some embodiments, when the scale system 100 is coupled to a checkout terminal, only the scale plate 110, the window 111 and, a portion of the optical sensor module 120 is visible to the user.

Next referring to FIG. 9, a checkout terminal 900 that may utilize a scale system 100 according to some embodiments is shown. The checkout terminal 900 comprises a hood portion 910, a support portion 920, a point of sale (POS) portion 940, a station portion 950, and a bagging station 960. In some embodiments, the scale system 100 may be inserted into an opening of the station portion 950 under an item placement area. One or more controllers of the scale system 100 may be housed within the station portion 950, the support portion 920, or the bagging station 960. In some embodiments, the checkout terminal 900 may comprise additional optical sensors housed within the hood portion 910 and/or a wing kit 930 that positions the optical sensors at different heights and angles to provide different points of views over the item placement area above the scale system 100.

The checkout terminal 900 in FIG. 9 is provided as an example only. Embodiments of the scale system 100 described herein may be used with variously configured checkout terminals without departing from the spirit of the present disclosure.

Next referring to FIG. 10, a block diagram of a checkout terminal system for facilitating retail transactions is shown. In FIG. 10, a checkout terminal 900 includes a checkout terminal controller 160 and a scale system 100.

The controller 160 comprises a control circuit 162, a memory 161, and a network interface device 163. The controller 160 may be mounted to the scale system 100 and/or housed in a station portion, a support portion and/or a bagging station of a checkout terminal. The control circuit 162 may comprise one or more of a processor, a microprocessor, a central processing unit (CPU), a graphics processing unit (GPU), an application-specific integrated circuit (ASIC), and the like and may be configured to execute computer-readable instructions stored on one or more computer-readable storage memory 161. The computer-readable storage memory 161 may comprise volatile and/or non-volatile memory and have stored upon it, computer-readable instructions which, when executed by the control circuit 162, causes the control circuit 162 to utilize the components of the scale system 100 to facilitate checkout transactions. In some embodiments, the controller 160 may be implemented with a plurality of memory devices and/or processors located in different locations of a checkout terminal such as a support portion, a hood portion, a POS portion, a station portion, and/or a bagging station. In some embodiments, the computer-executable instructions may cause the control circuit 162 of the controller 160 to perform one or more steps described with reference to FIG. 11 herein. In some embodiments, the computer-executable instructions may cause the control circuit 162 of the controller 160 to perform one or more steps in the processes and methods described in U.S. Provisional Application No. 63/310,001. The network interface device 163 may comprise a data port, a wired or wireless network adapter, and the like. In some embodiments, the controller 160 may communicate with a retailer backend system and one or more databases via a network such as a local network, a private network, or the Internet via the network interface device 163 to identify items and process retail transactions.

The scale system 100 comprises an RFID controller 145, an RFID antenna 140, load cells 115, an EAS controller 135, an EAS label deactivator 130, an optical sensor controller 125, and an optical sensor module 120. In some embodiments, a junction device 165 of the scale system 100 is configured to provide communication connections between components of the scale system enclosed within an enclosure and components of the scale system outside of the enclosure. In some embodiments, the junction device 165 provides an electrical connection between the RFID controller 145 and the RFID antenna 140. In some embodiments, the RFID controller 145 and/or the optical sensor controller 125 are configured to provide item identifiers to controller 160. In some embodiments, the junction device 165 provides a connection between the load cells 115 and the checkout terminal controller 160. In some embodiments, the load cells 115 are configured to send a signal indicating a measured weight to controller 160. In some embodiments, the junction device 165 provides a connection between the EAS label deactivator 130 and the EAS controller 135. In some embodiments, the junction device provides a connection between the optical sensor module 120 and the optical senso controller 125. In some embodiments, the junction box further supplies power from an external power source to one or more of the other components of the scale system 100.

In some embodiments, the EAS controller 135 may be configured to control and modulate the EAS label deactivator 130 based on communications with the checkout terminal controller 160. In some embodiments, the EAS controller 135 may execute an EAS software module with a frontend user interface component, a device integration library component, a Java device layer integration service component, a serial communication layer, and an EAS device controller software. In some embodiments, the frontend user interface component is configured to serve as part of a checkout terminal system that allows for EAS-related user messaging and control of the EAS device (e.g. enabling, disabling, and tag deactivation) via a Java device integration library. In some embodiments, the frontend user interface component further Facilitates communication between the frontend user interface and a Java device layer via a standard messaging protocol such as MQTT. In some embodiments, the java device layer integration service component is configured to standardize and facilitate state management and control of the EAS device via Java serial libraries. In some embodiments, the serial communication layer comprise serial messaging controlled through Java serial libraries from the device integration library for bidirectional communication between the EAS controller software and the Java device layer. In some embodiments, the EAS device controller software Exists on the physical EAS device controller that sends serial messages representing tag detection events (both non-de-activatable “hard” tags and de-activatable “soft” tags). In some embodiments, the EAS device controller further receives serial messages for enabling and disabling EAS tag deactivation. For example, if weight measurement is currently be taken or RFID tags are currently being read, the checkout terminal controller 160 may prevent the EAS label deactivator 130 from being activated through messages to the EAS controller 135.

In some embodiments, the checkout terminal controller 160 may further be connected to other components of a checkout terminal such as a display screen, a card reader, a hand scanner, a status indicator light, additional optical sensors, etc. In some embodiments, the checkout terminal controller 160 may combines data received from the scale system 100 with data received from other components (e.g. wing sensor kit, hood sensor kit, or hand scanner) to process checkout transactions.

Referring next to FIG. 11, a method for facilitating a checkout transaction at a checkout terminal with a scale system is shown. In some embodiments, the steps shown in FIG. 11 may be performed by a processor-based device such as a control circuit executing a set of computer-readable instructions stored on a computer-readable memory. In some embodiments, one or more steps of FIG. 11 may be performed by the checkout terminal 900 and/or the controller 160. In some embodiments, the steps of FIG. 11 may be at least partially executed by a central server that exchanges data with a plurality of checkout terminals.

To initiate checkout, a user may place products for purchase in a placement area of a checkout terminal. In some embodiments, the user is instructed to place the items in the placement area one at a time. In some embodiments, a variety of products associated with different product identifiers (e.g. UPC, SKU) may be simultaneously placed in the placement area in a group without presorting. In some embodiments, the products on the checkout terminal may be in a container such as a shopping basket or a tote bag. In some embodiments, the container may be transparent or partially see-through, allowing imaging of the content of the container from multiple angles. In some embodiments, the products may be clustered together and vertically stacked.

In step 210, the system identifies the item or items in the placement area based on signals from the RFID antenna 140 and the optical sensor module 120 of the scale system 100. In some embodiments, the system may alternatively or additionally utilize other sensors on a checkout terminal to perform step 210. In some embodiments, the identification may prioritize one sensor over the other. For example, the system may first attempt to read RFID tags, and, if no RFID tag is detected, may then attempt to detect for symbology second. In some embodiments, during or after step 210 the system may change the display of an indicator light in the placement area of the checkout terminal based on whether the item has been successfully identified, successfully weighted, and/or successfully EAS deactivated.

In step 220, if a variable weight item is present, the system also records the weight measurement from the load cells 115. In step 230, the system determines whether EAS label(s) are detected based on the signals from the EAS label deactivator 130 and/or the RFID antenna 140. In some embodiments, if an EAS label is detected, in step 240, the system further determines whether the EAS label is a soft deactivation label. In some embodiments, step 240 may be based on label identifier data detected by the EAS label deactivator 130 and/or the RFID antenna 140. If the EAS label is a soft deactivation label, in step 250, the system activates the EAS label deactivator 130 to deactivate the EAS label. In some embodiments, the system may be configured to determine that weight measurement and/or RFID detection are not active prior to actuating the EAS label deactivator to deactivate one or more EAS labels to avoid interferences. If the EAS label is a hard deactivation label, in step 255, the system notifies a store associate for assistance. In some embodiments, an indicator light of the checkout terminal may be changed to display an “assistance required” status (e.g. red) in step 255. In some embodiments, a message may be sent to an associate terminal identifying the checkout terminal number requiring assistance. After the EAS label is deactivated in either step 250 or 255, the system determines whether item identification is complete in step 260. In some embodiments, step 260 may be based on a user selecting a “scanning complete” input on a user interface of the checkout terminal. If more items remain, the process may return to step 210 to identify, weigh, and/or deactivate the EAS labels on more items for a transaction. Otherwise, the process continues to step 270 and the checkout terminal display payment instructions, process payment, and completes the transaction.

In some embodiments, the scale systems described herein provide an integrated device that provides weighing, optical sensing, RFID reading, and EAS label deactivation functions in a compact package. In some embodiments, the scale system may comprise a module in a modular checkout terminal system. In some embodiments, the scale system may be configured to be used in a variety of variously configured checkout terminals. In some embodiments, the scale system may be configured to be added to and removed from a checkout terminal with no or simple tooling (e.g. hand, screwdriver, wrench) on-site at a retail store without modifications to other structures of the checkout terminal.

In some aspects, the techniques described herein relate to a checkout terminal apparatus including: a scale plate; a frame load plate under the scale plate; a plurality of load cells mounted on the frame load plate under an edge portion of the scale plate, the load cells being configured to output signals indicating a weight of an item placed on the scale plate; and an electronic article surveillance (EAS) label deactivator positioned between the scale plate and the frame load plate, the EAS label deactivator being configured to deactivate EAS labels on items placed on the scale plate.

In some aspects, the techniques described herein relate to a method for retail checkout including: determining, with a control circuit of a checkout terminal system having a scale system, a weight of one or more items placed on a scale plate of the scale system; processing a transaction based on the weight of the one or more items; and actuating an EAS label deactivator to deactivate one or more EAS labels on the one or more items; wherein the scale system includes: the scale plate; a frame load plate under the scale plate, a plurality of load cells mounted on the frame load plate under an edge portion of the scale plate configured to output signals indicating the weight of items placed on the scale plate; and the EAS label deactivator positioned between the scale plate and the frame load plate.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A checkout terminal apparatus comprising:
a scale plate;
a frame load plate under the scale plate;
a plurality of load cells mounted on the frame load plate under the scale plate, the load cells being configured to output signals indicating a weight of an item placed on the scale plate; and
an electronic article surveillance (EAS) label deactivator positioned between the scale plate and the frame load plate, the EAS label deactivator being configured to deactivate EAS labels on items placed on the scale plate.

2. The checkout terminal apparatus of claim 1, further comprising:
a Radio Frequency Identification (RFID) antenna positioned between the scale plate and the frame load plate.

3. The checkout terminal apparatus of claim 2, wherein the RFID antenna is positioned above the frame load plate and below the EAS label deactivator.

4. The checkout terminal apparatus of claim 1, further comprising:
an enclosure which, along with the scale plate, encloses the frame load plate, the plurality of load cells, and the EAS label deactivator.

5. The checkout terminal apparatus of claim 4, further comprising one or more drainage capture plates and one or more drainage capture tubes;
wherein a bottom side of the enclosure comprises drainage openings that allow liquid to drain out of the one or more drainage capture tubes via the one or more drainage capture plates positioned below the enclosure.

6. The checkout terminal apparatus of claim 4, wherein the enclosure further comprises mounting brackets for one or more of an RFID controller, an EAS deactivation controller, or a checkout terminal controller.

7. The checkout terminal apparatus of claim 4, wherein the enclosure comprises a coupler for coupling to a checkout terminal configured to process transactions based on signals from the plurality of load cells and selectively activate the EAS label deactivator.

8. The checkout terminal apparatus of claim 1, wherein the EAS label deactivator comprises a coil antenna mounted on and spaced apart from the frame load plate via one or more brackets.

9. The checkout terminal apparatus of claim 1, wherein the EAS label deactivator is positioned between the plurality of load cells on the frame load plate.

10. The checkout terminal apparatus of claim 1, wherein the scale plate rests on the plurality of load cells via one or more of a base carrier plate, a frame load cell, or a load cell cover.

11. The checkout terminal apparatus of claim 1, further comprising an optical sensor device mounted under the scale plate and configured to capture symbology information and/or images from an item above on the scale plate.

12. The checkout terminal apparatus of claim 11, wherein the optical sensor device comprises two or more cameras angled to capture different fields of view.

13. The checkout terminal apparatus of claim 11, wherein the optical sensor device is at least partially surrounded by a coil antenna of the EAS deactivator.

14. The checkout terminal apparatus of claim 1, further comprising a cable junction device mounted under the frame load plate, wherein the cable junction device provides electrical connection between two or more of the load cells, the EAS label deactivator, an EAS deactivation controller, and a checkout terminal controller.

15. The checkout terminal apparatus of claim 1, wherein the scale plate comprises an indicator light for indicating a status associated with an item on the scale plate.

16. A method for retail checkout comprising:
determining, with a control circuit of a checkout terminal system having a scale system, a weight of one or more items placed on a scale plate of the scale system;
processing a transaction based on the weight of the one or more items; and
actuating an EAS label deactivator to deactivate one or more EAS labels on the one or more items;
wherein the scale system comprises:
the scale plate;
a frame load plate under the scale plate;
a plurality of load cells mounted on the frame load plate under the scale plate configured to output signals indicating the weight of items placed on the scale plate; and
the EAS label deactivator positioned between the scale plate and the frame load plate.

17. The method of claim 16, further comprising:
identifying the one or more items based on signals from an optical sensor module or an RFID antenna positioned between the scale plate and the frame load plate.

18. The method of claim 16, further comprising:
detecting, based on a signal from the EAS label deactivator, whether an EAS label is present on the scale plate prior to actuating the EAS label deactivator to deactivate one or more EAS labels.

19. The method of claim 18, further comprising:
determining, based on a signal from the EAS label deactivator, whether the EAS label is a hard deactivation label or a soft deactivation prior to actuating the EAS label deactivator to deactivate one or more EAS labels.

20. The method of claim 18, further comprising:
determining that weight measurement and/or RFID detection are not active prior to actuating the EAS label deactivator to deactivate one or more EAS labels.
